(19) United States
(12) Patent Application Publication
(10) Pub. No.: US 2017/0047069 A1
(43) Pub. Date: Feb. 16, 2017

(54) VOICE PROCESSING METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Yujun WANG, Tianjin (CN)

(21) Appl. No.: 15/243,839

(22) Filed: Aug. 22, 2016

Related U.S. Application Data
(63) Continuation of application No. PCT/CN2016/088896, filed on Jul. 6, 2016.

(30) Foreign Application Priority Data
Aug. 12, 2015 (CN) 201510497684.5

(51) Int. Cl. G10L 15/28; G10L 15/08

(52) U.S. Cl. CPC G10L 15/285; G10L 15/08

(57) ABSTRACT

An embodiment of the present disclosure discloses a voice processing method and device. The voice processing method comprises: when a current recognition thread acquiring a voice data packet stored by a set rule; calling a voice recognition example to perform voice recognition processing on the acquired voice data packet according to the acquired voice data packet; determining if other voice data packets to be processed exist after the processing of the acquired voice data packets is completed; and if yes, returning to the steps of the current recognition thread acquiring a voice data packet stored by the set rule to continuous perform voice recognition processing other voice data packets if the voice data packets to be processed do exist, wherein the acquired data packets and other voice data packets belong to different voice connections. The resources of the voice recognition server can be fully utilized to process voice requests.

### CROSS-REFERENCE TO RELATED APPLICATIONS

The present disclosure is a continuation of International Application No. PCT/CN2016/088896 filed on Jul. 6, 2016, which is based upon and claims priority to Chinese Patent Application No. 201510497684.5, entitled “VOICE PROCESSING METHOD AND DEVICE”, filed on Aug. 12, 2015, the entire contents of all of which are incorporated herein by reference.

### TECHNICAL FIELD

The present disclosure generally relates to the technical field of voice processing, in particular to a voice processing method and device.

### BACKGROUND

Internet-based voice recognition cloud service can help users perform voice searches, voice input, voice dialog, etc. As shown in FIG. 1, in those services, voices to be processed are transmitted from user terminals to a voice recognition server via the Internet, and recognition results obtained by the voice recognition server are fed back to the users via the original route to be displayed to users. User requests for the Internet-based voice recognition services are great in number and increase day by day, so the original limited recognition resources become in more and more shortage. It is thus clear that, for those skilled in this field, that the resources of the voice recognition server can be fully utilized to process voice requests and that the voice recognition server can recognize more voice requests in a unit of time are problems urgently need to be solved.

Two existing solutions are respectively as follows.

First Existing Solution:

As shown in FIG. 2, in a voice recognition server, every physical core of the recognition server is created with a voice recognition thread. In order to feed voice recognition results to users in real time and reduce user's waiting time, when a user inputs a voices, the voice requested by a user to be recognized is divided into voice data packets in a unit of 1 s and the voice data packets are sent to the voice recognition server (as shown in request 1 and packet 1, request 1 and packet 2 in FIG. 2). In this solution, a voice connection is created for the voice data packets from one client, and the voice connection is bound with a voice recognition thread and a voice recognition example at the same time. This means that, one voice recognition thread serves the voice data packets requested by one voice connection only.

During implementing the application, the inventor found that, when the voice recognition thread processes the voice data packets in a voice length of 1 s, the real-time rate is usually 0.6-0.9, which means that the recognition of the voice data packets of 1 s can be completed within 0.6 s-0.9 s. It is thus clear that, the recognition speed of the voice recognition thread is higher than the voice input speed of the user. In this way, the voice recognition thread waits for a next voice data packet requested by a voice connection after completing the processing of a voice data packet requested by the voice connection in link with the server, and the voice recognition thread is in an idle state. Those skilled in this field understand that an idle voice recognition thread indicates that the resources of the voice recognition server are not fully utilized, and that the utilization rate of the resources of the voice recognition thread server is low.

Second Existing Solution:

Every physical core in the voice recognition server is created with a plurality of voice recognition threads, and established with voice recognition examples as many as the voice recognition threads, which means that one physical core of the recognition server is needed to provide services for a plurality of voice recognition threads. For example, a recognition server has 12 logistic processor physical cores, and can be created with 48 groups of voice connections, voice recognition threads and voice recognition examples.

In the second existing solution, after a voice recognition thread completes processing of the currently processed voice data packet, the physical core corresponding to the voice recognition thread is in idle state, and by this time, other voice recognition threads with voice data packets to be processed scramble for the idle physical core. The voice recognition threads are out of control during switching, and usually a plurality of voice recognition threads scramble for one physical core, resulting in switching among the physical core among the voice recognition threads. Thus, the physical core is not idled, but a part of the resources of the physical core is consumed due to switching among the voice recognition threads and is still not utilized to process the voice requests. It is thus clear that, the second existing solution which simply depends on an increase in the number of the voice recognition threads also has the problem that the resources of the voice recognition server cannot be fully utilized to process the voice requests.

It is thus clear that, the existing solutions fail to fully utilize the resources of the voice recognition server to process the voice requests.

### SUMMARY

For the reason that the existing solutions fail to fully utilize the resources of the recognition server to process voice requests, the present disclosure discloses a voice processing method and device for solving the above problem or for at least partly solving the above problem.

According to one aspect of the present disclosure, the present disclosure discloses a voice processing method, including: when a current voice recognition thread acquiring a voice data packet stored by a set rule; calling a voice recognition example to perform voice recognition processing on the acquired voice data packet; determining if other voice data packets to be processed exist after the processing of the acquired voice data packets is completed; and if yes, returning to the steps of the current voice recognition thread acquiring a voice data packet stored by the set rule to continuously perform voice recognition processing of other voice data packets, wherein the acquired voice data packets and other voice data packets belong to different voice connections.

According to another aspect of the present disclosure, the present disclosure also discloses an electronic device for voice processing, including at least one processor; and a memory communicably connected with the at least one processor for storing instructions executable by the at least one processor, wherein execution of the instructions by the at least one processor causes the at least one processor to: a current voice recognition thread acquire voice data packets stored by a set rule; call a voice recognition example to perform voice recognition processing on the acquired voice data packets; determine if other voice data packets to be processed exist after the processing of the acquired voice data packets is completed; return to the current voice recognition thread acquiring a voice data packet stored according to the set rule, and continuous to perform voice recognition processing on other voice data packets if other voice data packets to be processed do exist, wherein the acquired data packets and other voice data packets belong to different voice connections.

According to another aspect of the present disclosure, the present disclosure discloses a non-transitory computer readable medium storing executable instructions that, when executed by an electronic device, cause the electronic device to: a current voice recognition thread acquire a voice data packet stored according to a set rule; call a voice recognition example to perform recognition processing on an acquired voice data packet; determine if other voice data packets to be processed exist after completing the processing the acquired voice data packets; if yes, return to the current voice recognition thread acquiring a voice data packet stored according to the set rule, and continue to perform voice recognition processing on other voice data packets, wherein the acquired data packet and other voice data packets belong to different voice connections.

The present disclosure has the following beneficial effects:

through the voice processing solution according to this embodiment of the present disclosure, the current voice identification thread does not provide a processing service for only one voice connection. After the processing of the voice data packet corresponding to the current voice connection is completed, which means that the current voice recognition thread is in an idle state, the current voice recognition thread actively determines if there are voice data packets to be processed for other requests, and if yes, directly acquires one of the voice data packets to be processed of other requests to perform processing. For the voice processing solution according to this embodiment of the present disclosure, on the one hand, the voice recognition thread in the idle state actively acquires other voice data packets to be processed to perform voice processing, so, unlike voice recognition threads in the prior art, the voice recognition thread does not have the problem of waiting for a next voice data packet corresponding to a voice connection and therefore causing waste of resources. On the other hand, in idle state, the voice recognition thread according to this embodiment of the present disclosure changes the idle state of a corresponding physical core thereof by actively acquiring other voice data packets to be processed, so resources of the physical core can be fully utilized. Switching between voice recognition threads does not occur in the whole process. All resources of the physical core corresponding to the voice recognition thread are utilized to process the voice data packet. Thus, the problem of consuming the resources of the physical core due to the switching between the voice recognition threads in the existing processing solutions can be effectively avoided. Moreover, the switching between the voice recognition threads is carried out by a processor according to a clock cycle thereof. This means that, a voice recognition thread may stop processing a voice data packet for a while, and begins to process the voice data packet corresponding to another voice recognition thread, so the switching between the voice recognition threads will result in decline in the processing speed of a single voice request. In this embodiment of the present disclosure, switching of the voice recognition threads does not occur, so the problem of decline in the processing speed of a single voice request caused by the switching of the voice recognition threads can be avoided.

The above description is a summary of the solution of the present disclosure. In order to more clearly describe the technical means of the present disclosure, practice can be made according to the contents of the description. Moreover, in order to ensure that the above and other objectives, characteristics and advantages of the present disclosure are more understandable, embodiments of the present disclosure are described below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic view of the existing voice interaction cloud.

FIG. 2 is a schematic view of interaction of the existing voice recognition.

FIG. 3 is a step flow chart of a voice processing method in accordance with some embodiments.

FIG. 4 is a step flow chart of a voice processing method in accordance with some embodiments.

FIG. 5 is a performance comparison diagram of voice request processing by the voice processing method in accordance with some embodiments.

FIG. 6 illustrates a flow chart of startup and interrupt of a voice processing system for executing of the voice processing method in accordance with some embodiments.

FIG. 7 illustrates a schematic view of a life cycle of a voice data packet in the voice processing process in accordance with some embodiments.

FIG. 8 is a structure diagram of a voice processing device in accordance with some embodiments.

FIG. 9 is a structure diagram of a voice processing device in accordance with some embodiments.

FIG. 10 schematically illustrates a block diagram of an electronic device for executing the method in accordance with some embodiments.

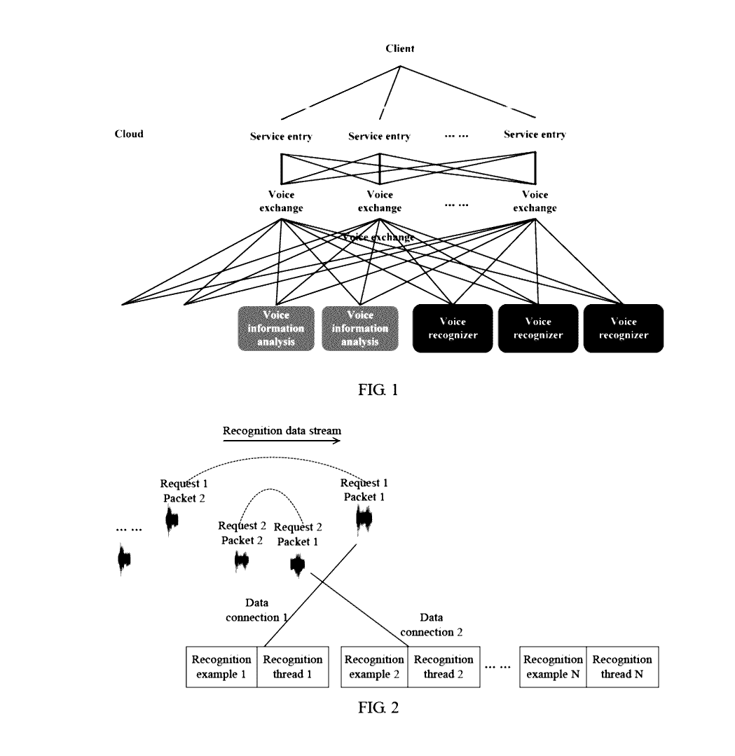

### DESCRIPTION OF THE EMBODIMENTS

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present invention, not all the embodiments of the present disclosure. Based on the embodiments in the present disclosure, those ordinarily skilled in this field can obtain other embodiments without creative labor, which all shall fall within the protective scope of the present disclosure.

### Embodiment 1

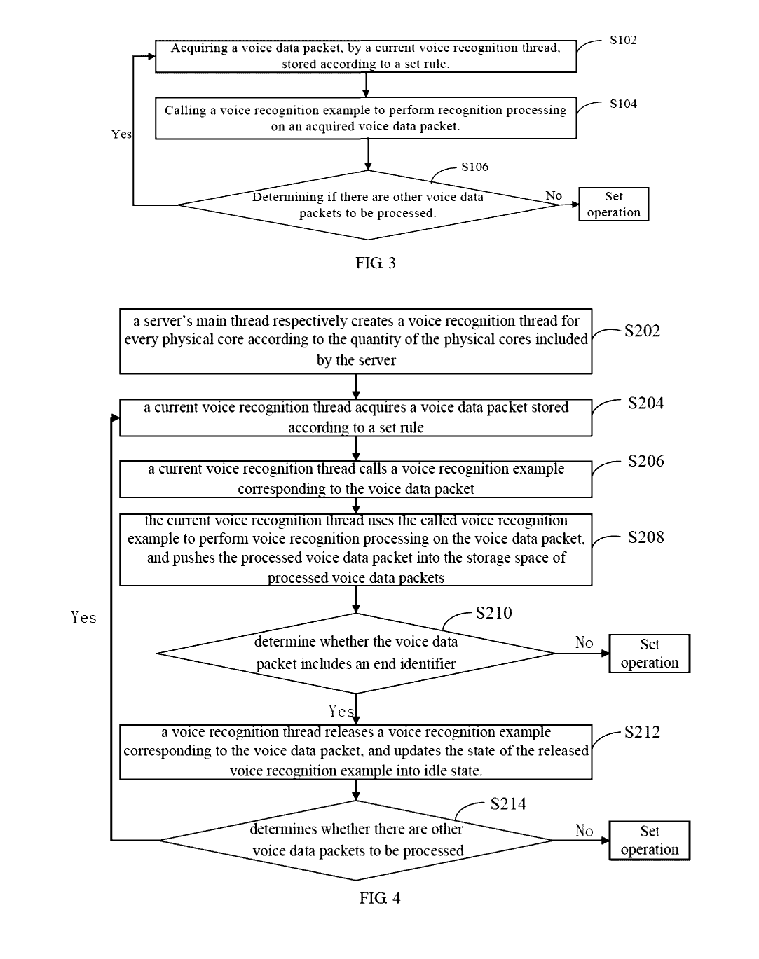

Refer to FIG. 3, which is a step flow chart of a voice processing method according to the first embodiment of the present disclosure.

The voice processing method according to the embodiment of the present disclosure includes the following steps:

Step S102: A current voice recognition thread acquires a voice data packet stored according to a set rule.

In response to actual demands, the set rule for storing the voice data packet can be set by those skilled in this field. The embodiment of the present disclosure has no specific limit in the set rule. For example, the rule is set in a way that a next voice data packet of the voice connection request is not stored before the processing of a previous voice data packet processed by the a voice connection request is completed. For example, the rule is set in a way that the next voice data packet of the voice connection request is stored after the processing of a previous voice data packet processed by the a voice connection request is completed.

Wherein, each stored voice data packet can be stored in any appropriate manner. For example, a queue is set in a recognition server, and voice data packets are stored in the set queue in a sequence of storage time. For example again, a storage pool is set, and voice data packets to be stored are stored in the storage pool.

Step S104: Call a voice recognition example to perform recognition processing on an acquired voice data packet.

When a voice is being recognized, the voice recognition thread assigns a voice recognition example for every successfully established voice connection, wherein a voice connection processes all voice data packets requested by a voice request. Wherein, the successfully established voice connections are connections which have been assigned to process voice requests. A voice recognition example stores the current recognition status and recognition history of a current voice request. Through the recognition history, data of a currently recognized voice data packet can be correlated with the data of the previously processed voice data packets in a semantic way to successfully process the current voice data packet.

Step S106: determine if there are other voice data packets to be processed after the processing of the acquired voice data packets is completed; if yes, return to step S102, and if not, execute a set operation.

Those skilled in this field can understand that, the server usually processes a plurality of voice connections at the same time, while each voice connection corresponds to a plurality of voice data packets, so during the specific realization process, the recognition server stores a plurality of voice data packets to be processed at the same time.

In this embodiment, after processing the voice data packets requested by the current voice connection, the current voice recognition thread actively acquires other voice data packets to be processed to perform voice processing until all voice data packets to be processed are completely processed.

It should be note that, in response to actual demands, the set operation can be set by those skilled in this field. For example, the operation is set to stop and release the voice recognition thread when it is determined that no voice data packet to be processed exists.

Through the voice processing method according to this embodiment of the present disclosure, the current voice identification thread does not provide a processing service for only one voice connection. After the processing of the voice data packet corresponding to the current voice connection is completed, which means that the current voice recognition thread is in an idle state, the current voice recognition thread actively determines if there are voice data packets to be processed for other requests, and if yes, directly acquires one of the voice data packets to be processed for other requests to perform processing. For the voice processing method according to this embodiment of the present disclosure, on the one hand, the voice recognition thread in the idle state actively acquires other voice data packets to be processed to perform voice processing, so, unlike voice recognition threads in the prior art, the voice recognition thread does not have the problem of waiting for a next voice data packet corresponding to a voice connection, and therefore avoids waste of resources. On the other hand, in idle state, the voice recognition thread according to this embodiment of the present disclosure changes the idle state of a corresponding physical core thereof by actively acquiring other voice data packets to be processed, so resources of the physical core can be fully utilized. Switching between voice recognition threads does not occur in the whole process. All resources of the physical core corresponding to the voice recognition thread are utilized to process the voice data packet. Thus, the problem of consuming the resources of the physical core due to the switching between the voice recognition threads in the existing processing methods can be effectively avoided. Moreover, the switching between the voice recognition threads is carried out by a processor according to a clock cycle thereof. This means that, a voice recognition thread may stop processing a voice data packet for a while, and begins to process a voice data packet corresponding to another voice recognition thread, so the switching between the voice recognition threads will result in decline in the processing speed of a single voice request. In this embodiment of the present disclosure, switching of the voice recognition threads does not occur, so the problem of decline in the processing speed of a single voice request caused by the switching of the voice recognition threads can be avoided.

### Embodiment 2

Refer to FIG. 4, which is a step flow chart of a voice processing method according to the second embodiment of the present disclosure.

The voice processing method according to the embodiment of the present disclosure specifically includes the steps as follows.

Step S202: a server's main thread respectively creates a voice recognition thread for every physical core according to the quantity of the physical cores included by the server.

For example, a server includes 12 physical cores, and the main thread of the server respectively creates a corresponding voice recognition thread for the 12 physical cores after a voice processing system is started. In order to enhance the concurrency level of voice request processing, more than 12 voice connections and voice recognition examples can be established. In this way, the server can process more than 12 voice requests at the same time, wherein every voice connection is used for processing all voice data packets requested, by a voice connection, for processing. After completing the recognition of a voice data packet, a voice recognition thread automatically acquires another voice data packet to be processed, and calls a voice recognition example corresponding to the acquired voice data packet to perform voice recognition processing.

In this embodiment of the present disclosure, all voice recognition threads process voice data packets in parallel, and all voice recognition threads employ the same method to process the voice data packets. Therefore, in this embodiment of the present disclosure, processing of a voice data packet by only one voice recognition thread is used as an example for description. The voice data packet processing flow of other created voice recognition threads can be seen in this embodiment of present disclosure and therefore are not repeatedly described.

In this embodiment of the present disclosure, the quantity of the voice recognition threads is equal to the quantity of logic cores of the server, namely the physical cores included by the server, so the voice recognition threads are not switched or randomly scrambled for processor resources.

In this embodiment of the present disclosure, every physical core is created with a voice recognition thread; every voice recognition thread can establish a voice connection for a voice connection request; and the successfully established voice connection processes all voice data packets sent by the corresponding voice connection request.

Step S204: a current voice recognition thread acquires a voice data packet stored according to a set rule.

A sever is needed to process the voice data packets requested by a plurality of voice connections, so the server stores a plurality of voice data packets to be processed. And those voice data packets are required to follow the set rule when being stored on the server.

An optimal mode of storing voice data packets according to the set rule is as follows.

S1: a voice connection to which a voice data packet belongs determines if the voice data packets corresponding to the voice connection is stored in a storage space of voice data packets to be processed, a storage space of voice data packets which are being processed and a storage space of the processed voice data packets; wherein, the server can be pre-set with three storage spaces, respectively the storage space of voice data packets to be processed, the storage space of voice data packets which are being processed and the storage space of the processed voice data packets; and those three storage spaces may be storage queues or storages pools.

Voice data packets to be processed are stored in the storage space of voice data packets to be processed; an idle voice recognition thread can acquire the voice data packets to be processed from the storage space, and store the voice data packets into the storage space of voice data packets which are being processed to perform voice processing. When completing the processing of the voice data packets, the voice recognition thread stores the completed voice data packets into the storage space of the processed voice data packets. The voice connection to which the voice data packets belongs scans the storage space of the processed voice data packets, and acquires recognition results corresponding to the processed voice data packets. By this time, if a next voice data packet has arrived, the voice connection stores the next voice data packet into the storage space of voice data packets to be processed.

S2: if the voice data packet corresponding to the voice connection is not stored, the voice data packets will be stored into the storage space of voice data packets to be processed.

When storing the voice data packet to be processed on the server, the voice connection to which the voice connection packet belongs is required to ensure that a request for processing the next voice data packet is sent to the server after the request previous voice data packet has been completely processed. Therefore, the voice connection is needed to ensure that all the three storage spaces do not store the voice data packet corresponding to the voice connection, and then can store the next data packet into the server.

Step S206: a current voice recognition thread calls a voice recognition example corresponding to the voice data packet.

During initialization, a server initializes the voice recognition example, and the initialized voice recognition example can be stored in a preset voice recognition example list. When needed to be called during the voice recognition process, the voice recognition example can be called from preset list.

An optimal method of calling a voice recognition example corresponding to the voice data packet is as follows.

S1: determine if the voice recognition example list stores a voice recognition example corresponding to a voice connection to which the voice data packet belong; and if yes, executes S2; and if not, executes S3.

Every voice connection established in the server is given a globally unique identifier (UID) by the server, and the identifier (UID) is an exclusive identifier. When a voice connection sends a voice data packet for the first time, the voice recognition thread assigns a voice recognition example to the voice connection, and establishes a correspondence relationship between the identifier of the voice recognition example and the UID corresponding to the voice connection.

When the voice connection sends a next voice data packet, the voice data packet sent by the voice connection carries with the UID corresponding to the voice connection; the voice recognition thread can determine the connection to which the voice data packet belongs according to the exclusive identifier carried by the voice data packet, and according to the established correspondence relationship between the identifier of the voice recognition example and the UID of the voice connection, determine the voice recognition example corresponding to the voice connection to which the voice data packet belongs.

Of course, if a current voice data packet is the first data packet by the voice connection thereof, the voice recognition thread does not assign a voice recognition example to the voice connection to which the voice data packet belongs, so the voice recognition example list does not include the voice recognition example corresponding to the voice connection to which the voice data packet belongs.

It should be note that, every voice connection corresponds to one voice request only, so the voice connection to which the voice data packet belongs and the voice request can be identified by giving every voice request with a UID.

S2: if the voice recognition example list stores a voice recognition example, directly call the voice recognition example corresponding to the voice connection.

If the voice recognition example list stores the voice recognition example corresponding to the voice connection to which the voice data packet belongs, it is proved that the current voice data packet is not the first voice data packet sent by the voice connection thereof. In such circumstances, the voice recognition example assigned to the voice connection is directly called to perform voice recognition on the current voice data packet.

S3: if voice recognition example list does not store a voice recognition example, call a currently idle voice recognition example from the voice recognition example list, and establish the correspondence relationship between the called voice recognition example and the voice connection to which the voice data packet belongs.

Wherein, the idle voice recognition example is a voice recognition example which does not establish the correspondence relationship with the voice connection.

Step S208: the current voice recognition thread uses the called voice recognition example to perform voice recognition processing on the voice data packet, and pushes the processed voice data packet into the storage space of processed voice data packets.

In this step, the current voice recognition thread pushes the processed voice data packet into the storage space of processed voice data packets for acquisition by the voice connection to which the voice data packet belongs.

The voice connection to which the voice data packet belongs scans the storage space of processed data packets according to the set rule to determine if the requested voice data packet has been processed, and if the voice data packet is scanned in the storage space, it is proved that the voice data packet has been processed, and the voice connection to which the voice data packet belongs can acquire the recognition result corresponding to the processed voice data packet.

Of course, during the specific realization process, a voice data packet list can be set in the storage space of processed voice data packets, and the voice data packet list is added with the UID corresponding to the voice connection to which the processed voice data packet belongs. The voice connection scans and determines if the set voice data packet list includes the corresponding UID thereof to determine if the requested voice data packet has been processed. If the corresponding UID is in the list, it is proved that the voice data packet has been processed, and then the voice connection can acquire the recognition result corresponding to the processed voice data packet.

Step S210: the current voice recognition thread determines if the voice data packet includes an end identifier; if yes, execute step S212, and if not, execute a set operation.

Wherein, the end identifier is used for indicating the last voice data packet corresponding to the voice connection to which the current voice data packet belongs.

In this step, the purpose that the current voice recognition thread determines if the vice data packet includes the end identifier is to determine if the voice data packets requested by the voice connection have been completely processed, and if yes, release the voice recognition example corresponding to the voice connection for use by other voice connections.

The set operation can be set by those skilled in this field upon actual demands, and this embodiment has no specific limit in the set operation. For example, the operation can be set to directly acquire other voice data packets to be processed.

Voice data requested by a voice connection are divided into a plurality of voice data packets, and the last data packet carries the end identifier. For example, voice data requested by a current voice data are divided into a total of five voice data packets; the previous five voice data packets respectively carry identifiers of the current voice data packets excluding the first voice data packet (for example, the identifiers carried by the voice data packets from the first to the fifth are respectively set as 1, 2, 3, 4, 5), while the sixth voice data packet is the last voice data packet, so the sixth voice data packet carries the end identifier for indicating that the current voice data packet is the last voice data packet (for example, the end identifier is set as −6).

The above description exemplifies only one mode of determining that the voice data packet is the last packet by providing the voice data packets with positive and negative marks. During specific realization process, those skilled in this field can set the end identifier by using any proper setting modes, for example, only the last voice data packet carries the set identifier, and when a data packet carries the set identifier, it can be determined that the data packet is the last voice data packet requested by the voice connection thereof. For example again, a non-last voice data packet can carry an identifier 1, while the last voice data packet carries an identifier 0, wherein the identifier 0 is defined as the end identifier.

Step S212: if a voice data packet includes an end identifier, a voice recognition thread releases a voice recognition example corresponding to the voice data packet, and updates the state of the released voice recognition example into idle state.

After the state of the voice recognition example is updated into idle state, the voice recognition example can be bound with other voice connection.

Step S214: a voice recognition thread determines if there are other voice data packets to be processed after completing the processing of the acquired voice data packets; if yes, returns to step S204, and if not, executes a set operation.

Those skilled in this field can understand that, the server usually processes a plurality of voice connection requests at the same time, while each voice connection request corresponds to a plurality of voice data packets, so during the specific realization process, the server stores a plurality of voice data packets to be processed at the same time in the storage space of voice data packets to be processed. In this embodiment, after processing the voice data packets requested by the current voice connection, the current voice recognition thread actively acquires other voice data packets to be processed to perform voice processing until all voice data packets to be processed are completely processed.

Wherein, the set operation can be set by those skilled in this field upon actual demands. For example, the operation is set to stop and release the voice recognition thread when it is determined that no voice data packet to be processed exists.

FIG. 5 is a performance comparison diagram of voice request processing by the voice processing method according to this embodiment (every physical core of a server is created with a voice recognition thread, and the voice recognition thread is bound with a voice recognition example, wherein every recognition thread processes voice requests corresponding to only one voice connection) and by an existing first voice processing method in the process of processing voice request.

The comparison diagram is generated after statistics operation of pressure test data obtained by pushing data of the same batch respectively into two voice processing systems, and the servers in those two voice processing systems used during the test respectively include 12 physical cores.

Wherein, the horizontal coordinate represents the maximum number of concurrent recognitions, namely the quantity of voice connections processed by the server at the same time; the vertical coordinate represents the voice recognition real-time rate, namely the time of the voice data packet corresponding to the voice processed by the voice recognition thread in 1 second. The voice recognition real-time rate can reflect the voice request processing performance of the server.

In FIG. 5, the line connecting the round dots indicates the performance curve of the voice request processing of the voice processing method in this embodiment; and the line connecting the rectangular blocks indicates the performance curve of the voice request processing of a current voice processing method bound with a first thread. From FIG. 5 it can be known that, as the maximum number of concurrent recognitions increases, the voice recognition real-time rates of the two voice recognition systems also increase. When the maximum number of concurrent recognitions is greater than 24, the advantages of the present disclosure become obvious. By this time, the real-time rate of the present disclosure also rises, but the rising trend is not obvious. It is thus clear that, the voice processing method according to this embodiment of the present disclosure can enhance the processing capability of the voice processing system.

During a specific realization process, a common challenge is to update voice models for voice recognition stored in the server. When it is needed to update the voice models for voice recognition stored in the server, the server is needed to be interrupted externally. An existing solution for processing the interruption is to directly interrupt all voice connections linking with the server, which affects the experience of users. For the voice processing method according to this embodiment of the present disclosure, after receiving an external request to interrupt to the server, the server's main thread maintains the established voice connection, continues to process the voice data packets requested by the established voice connections until all voice data packets requested by the voice connection have been completed, and then interrupts the voice connection. For un-established voice connections, the server's main thread does not accept the connection requests any more.

The specific process is as follows:

when receiving an external request to interrupt the sever, the server's main thread generates an interrupt identifier; according to the interrupt identifier, for voice connections which have been established in the server, the server's main thread continues to carry out the voice recognition processing on the voice data packets corresponding to the voice connections, and after the voice recognition processing of all the voice data packets corresponding to the voice connections is completed, interrupts the voice connection; and for voice connections which are not established in the server, the server's main thread directly cancels requests of establishing connections with the server, and stops establishing voice connections with the server.

The solution according to this embodiment of the present disclosure to process the external interrupt request continues to provide services for the established voice connections until all voice data packets requested by the voice connections are processed. For users, the voice recognition requests are not affected and not suddenly interrupted, so the experience of users can be improved.

Through the voice processing method according to this embodiment of the present disclosure, the current voice identification thread does not provide a processing service for only one voice connection. After the processing of the voice data packet corresponding to the current voice connection is completed, which means that the current voice recognition thread is in an idle state, the current voice recognition thread actively determines if there are voice data packets to be processed for other requests, and if yes, directly acquires one of the voice data packets to be processed for other requests to perform processing. For the voice processing method according to this embodiment of the present disclosure, on the one hand, the voice recognition thread in the idle state actively acquires other voice data packets to be processed to perform voice processing, so, unlike voice recognition threads in the prior art, the voice recognition thread does not have the problem of waiting for a next voice data packet corresponding to a voice connection, and therefore avoids waste of resources. On the other hand, in idle state, the voice recognition thread according to this embodiment of the present disclosure changes the idle state of a corresponding physical core thereof by actively acquiring other voice data packets to be processed, so resources of the physical core can be fully utilized. Switching between voice recognition threads does not occur in the whole process. All resources of the physical core corresponding to the voice recognition thread are utilized to process the voice data packet. Thus, the problem of consuming the resources of the physical core due to the switching between the voice recognition threads in the existing processing methods can be effectively avoided. Moreover, the switching between the voice recognition threads is carried out by a processor according to a clock cycle thereof. This means that, a voice recognition thread may stop processing a voice data packet for a while, and begins to process a voice data packet corresponding to another voice recognition thread, so the switching between the voice recognition threads will result in decline in the processing speed of a single voice request. In this embodiment of the present disclosure, switching of the voice recognition threads does not occur, so the problem of decline in the processing speed of a single voice request caused by the switching of the voice recognition threads can be avoided.

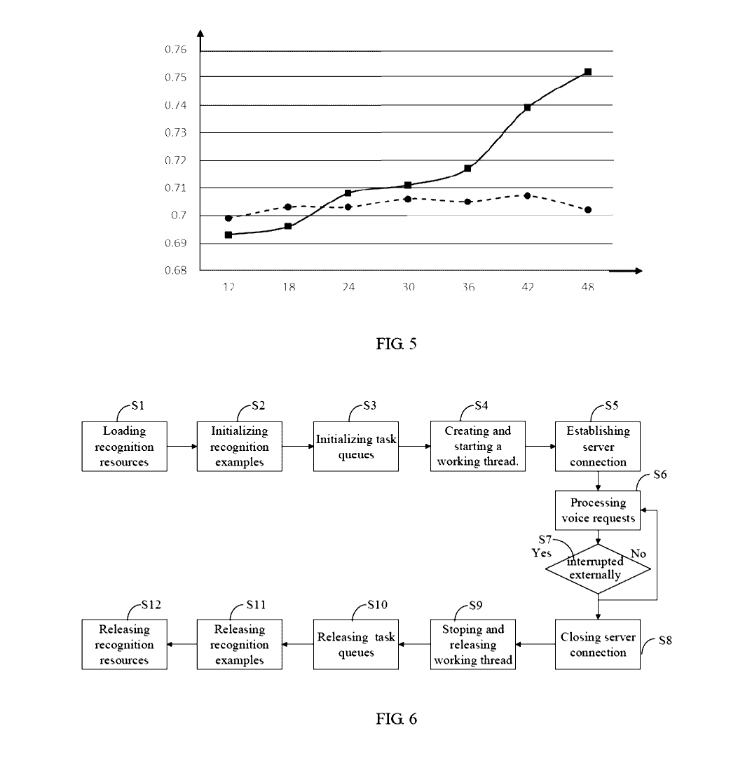

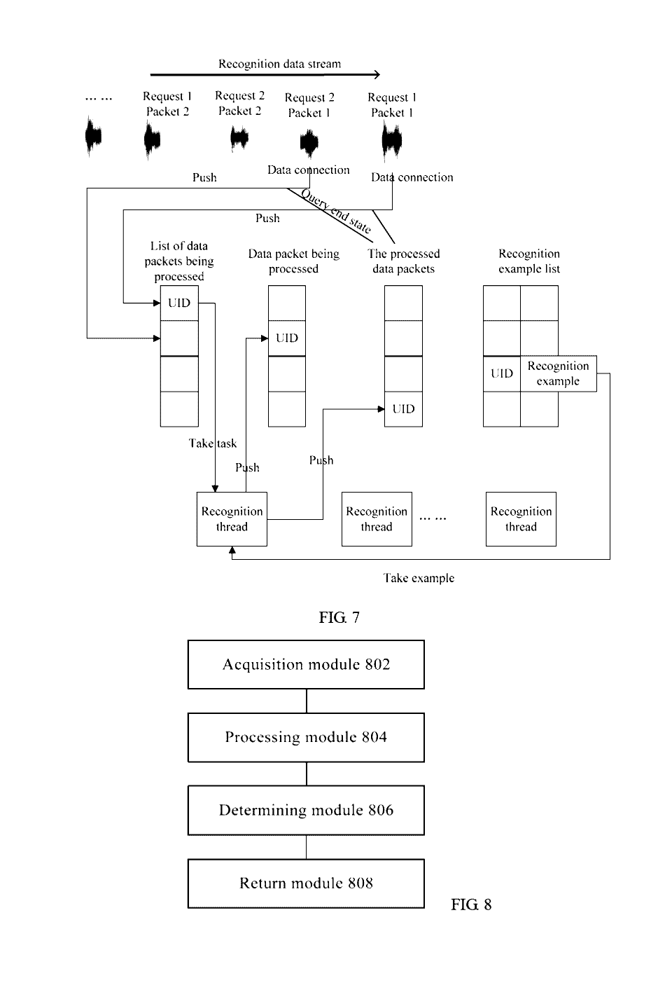

Refer to FIG. 6 below, wherein a voice processing method according to a specific embodiment of the present disclosure is described with a specific example.

FIG. 6 illustrates a flow chart of startup and interrupt of a voice processing system for executing of the voice processing method according to the second embodiment.

As shown in FIG. 6, a voice processing system, namely a server, executes the following operations in advance during startup.

S1: load recognition resources.

Wherein, the server uses corresponding recognition resources during voice recognition processing, so when the server is started, it is needed to load recognition resources in advance. The recognition resources are stored in a hard disk. The purpose of loading the recognition resources is to load the recognition resources in the hard disk to a server memory to avoid frequent access to the hard disk.

S2: initialize recognition examples.

Initializing recognition examples namely establishes a set number of voice recognition examples and stores the voice recognition examples in a voice recognition examples list. Before establishing voice connections, the voice recognition examples list may store initialized voice recognition examples only. However, after the server establishes voice connections, the voice recognition example list stores the correspondence relationships between the UIDs corresponding to the voice requests and the voice recognition examples.

S3: initialize task queues.

In this specific example, the server includes M physical cores; initialized task queues include queues of data packets to be processed, a list of data packets being processed, a list of processed data packets and a recognition example list; and each initialized task queue can store N targets and concurrently processes K (usually K=N) voice connections. This specific example is used to describe the subsequent flow.

S4: create and start a working thread.

Wherein the working thread is a voice recognition thread.

In this specific example, the server includes M physical cores, so when creating the voice recognition thread, the server main thread creates a voice recognition thread for every physical core, namely creating a total of M voice recognition threads. The quantity of the voice recognition threads is equal to the quantity of logic cores of the server, namely the quantity of the physical cores included by the server, so the voice recognition threads are not switched or randomly scramble for processor resources.

After the execution of the above operations is completed, the recognition server can execute S5 to establish voice connection with a client. In this specific example, in order to ensure that the resources of the server are fully utilized, all voice recognition threads created in S4 process voice data packets correspond to voice connections, which means that S6 is executed.

S6: process voice recognition requests.

Processing of a voice data packet in a voice recognition request is described below with reference to FIG. 3.

From FIG. 3 it can be known that, a voice recognition request corresponds to a voice connection. During the specific realization process, every voice request is given a UID, which means that a voice connection corresponds to a UID, and every voice connection receives a data packet from a corresponding voice request. A certain voice data packet included in a voice request corresponding to a UID is pushed in a queue of data packets to be processed, which follows the rule of “first come, first go”.

Pushing a new voice data packet into the queue of data packets to be processed should meet the following four conditions at the same time:

1. The queue is not full.

2. The UID corresponding to the voice request to which the voice data packet, requested to be pushed, belongs does not exist in the queue of data packets to be processed; and if the UID exists, it means that the previous voice data packet of the voice request corresponding to the UID is not processed.

3. The UID corresponding to the voice request to which the voice data packet, requested to be pushed, belongs does not exist in the list of data packets being processed; and if the UID exists, it means that the previous voice data packet of the voice request corresponding to the UID is being processed.

4. The UID corresponding to the voice request to which the voice data packet, requested to be pushed, belongs does not exist in the list of processed data packets; and if the UID exists, it means that the previous voice data packet of the voice request corresponding to the UID has been processed and is not acquired by the voice connection thereof.

In the case of failure to meet any one of the above four conditions, the voice connection will enter the waiting status, and until all the conditions are satisfied, push the next voice data packet of the served voice request. The flow of processing a voice data packet in a voice recognition request is as follows.

Step 1: when processing a voice data packet, a voice recognition thread acquires a voice data packet from a queue of data packets to be processed to perform the processing.

Step 2: a corresponding voice recognition example is found from a recognition example list according to the UID of a voice request carried in the voice data packet.

If the UID carried in the voice data packet is not bound with any voice recognition example, it means that the voice data packet is the first voice data packet requested by the voice request corresponding to the UID. By this time, an idle voice recognition example is found to be bound with the UID, and the successful binding means that the voice recognition example serves the bound voice request only.

Step 3: after a voice data packet to be recognized and the corresponding voice recognition example are obtained, the UID carried by the voice data packet is moved from the queue of data packets to be processed to the list of data packets being processed.

Moving the UID carried by the voice data packet from the queue of data packets to be processed to the list of data packets being processed represents that the voice data packet requested by the voice request corresponding to the UID is being processed.

Step 4: after processing the voice data packet corresponding to the UID, the voice recognition thread moves the UID from the list of data packets being processed into the list of processed data packets.

Moving the UID from the list of data packets being processed into the list of processed data packets represents that, the processing of the voice data packet is completed, and the feedback of the recognition is placed in a feedback area of the voice data packet. The voice connection which waits for the recognition feedback scans the list of processed data packets without stop. The voice connection acquires the recognition result once finding corresponding UID thereof and removes the UID from the “list of processed data packets”. If the last voice data packet of a voice request is being processed, except acquiring the recognition result, the voice connection also needs to release the UID and the voice recognition example in binding to represent that the recognition example is in idle state.

It is needed to be noted that, the above description is based on processing of one voice data packet by a single voice recognition thread. During specific realization process, all voice recognition threads acquire the voice data packets from the queue of data packets to be processed to perform processing, and move the UID carried by the voice data packets being processed to the list of data packets being processed, and move the UID carried by the processed voice data packets to the list of processed data packets. In the idle state, the voice recognition threads acquire voice data packets to be processed from the queue of data packets waiting for being processed to perform processing, thus realizing concurrent voice recognition.

When it is needed to update voice models for voice recognition in the server, the server is required to be interrupted externally. In this specific example, S8 is executed after an external interrupt request is received in S7.

S8: close server connection.

In this specific example, before close the server connection, close all voice connection, release all voice recognition examples, release all model resource and exit only after all established voice recognition tasks must be processed, and final recognition results be fed back (namely it is needed to process all voice data packets requested by the established voice connections). Specifically, after processing all established voice recognition tasks, execute the following operations in turn; S9: stop and release voice recognition threads; S10: release tasks queues; S11: release voice recognition examples; S12: release recognition resources.

For the voice processing method according to this embodiment of the present disclosure, on the one hand, as the quantity of the created voice recognition threads is equal to the quantity of logic cores of the server, namely the physical cores included by the server, so the voice recognition threads are not switched or randomly scramble for processor resources, thus enhancing the processing capability of the voice recognition system. On the other hand, these specific examples releases server calculation resources and voice recognition examples, so one voice recognition threads serves more than one voice request (which means that one voice recognition thread processes the voice data packets requested by more than one voice connection), thus enhancing the processing capability of the voice recognition system.

### Embodiment 3

Refer to FIG. 8, which illustrates a structure diagram of a voice processing device according to the third embodiment of the present disclosure.

The voice processing device according to this embodiment of the present disclosure includes an acquisition module 802 for acquiring, by a current recognition thread, voice data packets stored by a set rule; a processing module 804 for calling a voice recognition example to perform voice recognition processing on the acquired voice data packets; a determining module 806 for determining if other voice data packets to be processed exist after the processing of the acquired voice data packets is completed; and a return module 808 for returning to the acquisition module to continuous perform voice recognition processing other voice data packets if other voice data packets to be processed do exist, wherein the acquired data packets and other voice data packets belong to different voice connections.

Through the voice processing device according to this embodiment of the present disclosure, the current voice identification thread does not provide a processing service for only one voice connection. After the processing of the voice data packet corresponding to the current voice connection is completed, which means that the current voice recognition thread is in an idle state, the current voice recognition thread actively determines if there are voice data packets to be processed for other requests, and if yes, directly acquires one of the voice data packets to be processed of other requests to perform processing. For the voice processing device according to this embodiment of the present disclosure, on the one hand, the voice recognition thread in the idle state actively acquires other voice data packets to be processed to perform voice processing, so, unlike voice recognition threads in the prior art, the voice recognition thread does not have the problem of waiting for a next voice data packet corresponding to a voice connection and therefore avoids waste of resources. On the other hand, in idle state, the voice recognition thread according to this embodiment of the present disclosure changes the idle state of a corresponding physical core thereof by actively acquiring other voice data packets to be processed, so resources of the physical core can be fully utilized. Switching between voice recognition threads does not occur in the whole process. All resources of the physical core corresponding to the voice recognition thread are utilized to process the voice data packet. Thus, the problem of consuming the resources of the physical core due to the switching between the voice recognition threads in the existing processing methods can be effectively avoided. Moreover, the switching between the voice recognition threads is carried out by a processor according to a clock cycle thereof. This means that, a voice recognition thread may stop processing a voice data packet for a while, and begins to process a voice data packet corresponding to another voice recognition thread, so the switching between the voice recognition threads will result in decline in the processing speed of a single voice request. In this embodiment of the present disclosure, switching of the voice recognition threads does not occur, so the problem of decline in the processing speed of a single voice request caused by the switching of the voice recognition threads can be avoided.

### Embodiment 4

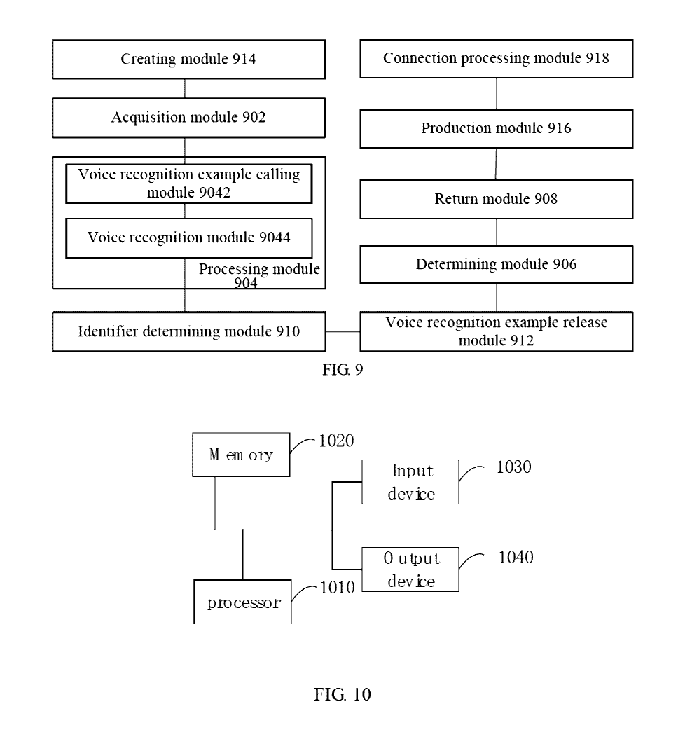

Refer to FIG. 9, which illustrates a structure diagram of a voice processing device according to the fourth embodiment of the present disclosure.

The fourth embodiment of the present disclosure is a further optimization of the voice processing device according to the third embodiment. The optimized voice processing device includes an acquisition module 902 for acquiring, by a current recognition thread, voice data packets stored by a set rule; a processing module 904 for calling a voice recognition example to perform voice recognition processing on the acquired voice data packets, a determining module 906 for determining if other voice data packets to be processed exist after the processing of the acquired voice data packets is completed; and a return module 908 for returning to the acquisition module to continuously perform voice recognition processing of other voice data packets if other voice data packets to be processed exist, wherein the acquired data packets and other voice data packets belong to different voice connections.

Optimally, the processing module 904 includes: a voice recognition example calling module 9042 for calling a voice recognition example corresponding to a voice data packet; and a voice recognition module 9044 for using the called voice recognition example to perform voice recognition processing on the voice data packet and push the processed voice data packet into the storage space of processed voice data packets for acquisition by the voice connection of the voice data packet.

Optimally, when calling the voice recognition example corresponding to the voice data packet, the voice recognition example calling module 9042 determines if the recognition example list stores the voice recognition example corresponding to the voice connection to which the voice data packet belongs, if yes, directly calls the voice recognition example corresponding to the voice connection; and if not, calls a currently idle voice recognition example from the voice recognition example list and establishes a correspondence relationship between the called voice recognition example and the voice connection to which the voice data packet belongs, wherein the idle voice recognition example is a voice recognition example which does not establish the corresponding relationship with the voice connection.

Optionally, the voice data packet is stored by the set rule in the following way: the voice connection to which the voice data packet belongs determines if the voice data packet corresponding to the voice connection are stored in a storage space of voice data packets to be processed, a storage space of voice data packets which are being processed and a storage space of the processed voice data packets, and if the voice data packet corresponding to the voice connection is not stored, stores the voice data packet into the storage space of voice data packets to be processed.

Optimally, the voice processing device according to this embodiment of the present disclosure also includes an identifier determining module 910 for determining if the voice data packet includes an end identifier after the voice recognition module 9044 pushes the processed voice data packet in the queue of the processed voice data packets, wherein the end identifier is used for indicating the last voice data packet corresponding to the voice connection to which the current voice data packet belongs, a voice recognition example release module 912 for releasing the voice recognition example corresponding to the voice data packet and updating the status of the released voice recognition example into idle state if the result obtained by the identifier determining module is yes.

Optimally, the voice processing device according to this embodiment of the present disclosure also includes: a creating module 914 which is used by the server's main thread to create a voice recognition thread for every physical core according to the quantity of physical cores included by the server before the acquisition module 902 is used by the current voice recognition thread to acquire the voice data packet stored by the set rule.

Optimally, the voice processing device according to this embodiment of the present disclosure also includes: a production module 916 for generating an interrupt identifier when the server's main thread receives an external request to interrupt the server, and a connection processing module 918 for, according to the interrupt identifier, for voice connections which have been established in the server, continuing to carry out the voice recognition processing on the voice data packets corresponding to the voice connections, and after the voice recognition processing of all the voice data packets corresponding to the voice connections is completed, interrupting the voice connection, and for voice connections which are not established in the server, directly canceling requests of establishing connections with the server, and stopping establishing voice connections with the server.

The voice processing method according to this embodiment is used for realizing the voice processing methods according to the first embodiment and the second embodiment, and has beneficial effects of the corresponding method embodiments, not repeated here.

The device embodiment described above is schematic, wherein units described as separable parts may be or may not be physically separated, and components displayed as units may be or may not be physical units, which means that the units can be positioned at one place or distributed on a plurality of network units. Some or all modules can be selected to fulfill the objective of the solution in the embodiment upon actual demands. Those ordinarily skilled in this field can understand and implement the present disclosure without creative work.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

FIG. 10 is a structural schematic diagram showing the electronic device for executing the method for adjusting a video above. As shown in FIG. 10, the electronic device includes:

one or more processors 1010 and memories 1020, in FIG. 10, one processor 1010 is taken as an example.

The electronic device for executing the method for adjusting the video may include: an input device 1030 and an output device 1040.

The processor 1010, the memory 1020, the input device 1030 and the output device 1040 are connected through buses or other connecting ways. In FIG. 10, a bus connection is taken as an example.

The memory 1020 is a non-transitory computer readable storage medium which may be used to store non-transitory software program, non-transitory computer-executable program and modules such as the program instructions/modules (such as the acquisition module 802, the processing module 804 the determining module 806 and the return module 808 shown in FIG. 8) corresponding to the method for adjusting the video according to the embodiment of the present disclosure. The processor 1010 executes various functions and applications of the electronic device and performs data processing by operating the non-transitory software programs, instructions and modules stored in the memory 1020, that is, executes the method for adjusting the video according to the method embodiments above.

The memory 1020 may include a program storage section and a data storage section. Wherein the program storage section may store operating system and application needed by at least one function, and the data storage section may store the established data according to the device for adjusting the video. In addition, the memory 1020 may include a high-speed random access memory, and may also include a non-transitory memory such as at least a disk memory device, flash memory device or other non-transitory solid-state storage devices. In some embodiments, the memory 1020 may include a remote memory away from the processor 1010. The remote memory may be connected to the device for adjusting the video via network. The network herein may include Internet, interior network in a company, local area network, mobile communication network and the combinations thereof.

The input device 1030 may receive input numbers or characteristics information, and generate key signal input relative to the user setting and function control of the device for adjusting the video. The output device 1040 may include display devices such as a screen.

The one or more modules are stored in the memory 1020, when executed by the one or more processors 1010, the methods for adjusting the video in the above method embodiments are executed.

The product may execute the method provided according to the embodiment of the present disclosure, and it has corresponding functional modules and beneficial effects corresponding to the executed method. The technical details not illustrated in the current embodiment may be referred to the method embodiments of the present disclosure.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that, the above embodiments are used to describe instead of limiting the technical solution of the present disclosure; although the above embodiments describe the present disclosure in detail, those ordinarily skilled in this field shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A voice processing method, comprising:
at an electronic device:
a current voice recognition thread acquiring a voice data packet stored according to a set rule;
calling a voice recognition example to perform recognition processing on an acquired voice data packet;
after completing the processing of the acquired voice data packets, determining whether other voice data packets to be processed exist;
if yes, returning to the current step of the current voice recognition thread acquiring a voice data packet stored according to the set rule, and continuing to perform voice recognition processing on other voice data packets, wherein the acquired voice data packet and other voice data packets belong to different voice connections.

2. The method according to claim 1, wherein the step of calling a voice recognition example to perform recognition processing on an acquired voice data packet comprises:
calling a voice recognition example corresponding to the voice data packet;
using the called voice recognition example to perform voice recognition processing on the voice data packet, and pushing the processed voice data packet into the storage space of processed voice data packets for acquisition by the voice connection to which the voice data packet belongs.

3. The method according to claim 2, wherein the step of calling a voice recognition example corresponding to the voice data packet comprises:
determining whether the voice recognition example list stores a voice recognition example corresponding to a voice connection of voice data packets;
if yes, directly calling the voice recognition example corresponding to the voice connection;
and if not, calling a currently idle voice recognition example from a voice recognition example list, and establishing the correspondence relationship between the called voice recognition example and the voice connection that the voice data packet belongs, wherein the idle voice recognition example is a voice recognition example which does not establish the corresponding relationship with the voice connection.

4. The method according to claim 1, wherein the voice data packet stored by the set rule is stored in a following way:
a voice connection to which the voice data packet belongs determining if the voice data packet corresponding to the voice connection is stored in a storage space of voice data packets to be processed, a storage space of voice data packets which are being processed and a storage space of the processed voice data packets;
and if the voice data packet corresponding to the voice connection is not stored, storing the voice data packet into the storage space of voice data packets to be processed.

5. The method according to claim 2, wherein after the step of pushing the processed voice data packet into the list of processed voice data packets, the method further comprises:
determining whether the voice data packet comprises an end identifier, wherein the end identifier is used for indicating the last voice data packet corresponding to the voice connection of the current voice data packet;
if yes, releasing a voice recognition example corresponding to the voice data packet, and updating the state of the released voice recognition example into idle state.

6. The method according to claim 1, wherein before the step of the current voice recognition thread acquiring the voice data packet stored by the set rule, the method further comprises:
a server's main thread respectively creating a voice recognition thread for every physical core according to the quantity of the physical cores comprised by the server.

7. The method according to claim 1, wherein the method further comprises:
when the sever main thread receives an external request for interrupting the server, generating an interrupt identifier;
according to the interrupt identifier, for voice connections which is established in the server, the server's main thread continues to carry out the voice recognition processing on the voice data packets corresponding to the voice connections, and after the voice recognition processing of all the voice data packets corresponding to the voice connections is completed, interrupts the voice connection;
and for voice connections which are not established in the server, directly canceling requests of establishing connections with the server, and stopping establishing voice connections with the server.

8. An electronic device, comprising:
at least one processor; and
a memory communicably connected with the at least one processor for storing instructions executable by the at least one processor, wherein execution of the instructions by the at least one processor causes the at least one processor to:
a current voice recognition thread acquire a voice data packet stored according to a set rule;
call a voice recognition example to perform recognition processing on an acquired voice data packet;
determine if other voice data packets to be processed exist after completing the processing the acquired voice data packets;
if yes, return to the current voice recognition thread acquiring a voice data packet stored according to the set rule, and continue to perform voice recognition processing on other voice data packets, wherein the acquired data packet and other voice data packets belong to different voice connections.

9. The electronic device according to claim 8, wherein execution of the instructions by the at least one processor causes the at least one processor to:
call a voice recognition example corresponding to the voice data packet;
use the called voice recognition example to perform voice recognition process on the voice data packet, and push the processed voice data packet into the storage space of processed voice data packets for acquisition by the voice connection that the voice data packet belongs.

10. The electronic device according to claim 9, wherein when calling the voice recognition example corresponding to the voice data packet, call a voice recognition example corresponding to the voice data packet comprises:
determining if the voice recognition example list stores the voice recognition example corresponding to the voice connection that the voice data packet belongs;
if yes, directly calling the voice recognition example corresponding to the voice connection;
and if not, calling a currently idle voice recognition example from a voice recognition example list, and establishes the correspondence relationship between the called voice recognition example and the voice connection that the voice data packet belongs, wherein the idle voice recognition example is a voice recognition example which does not establish the corresponding relationship with the voice connection.

11. The electronic device according to claim 8, wherein the voice data packet stored by the set rule is stored in a following way:
the voice connection that the voice data packet belongs determines whether the voice data packet corresponding to the voice connection is stored in a storage space of voice data packets to be processed, a storage space of voice data packets which are being processed and a storage space of the processed voice data packets;
and if the voice data packet corresponding to the voice connection is not stored, storing the voice data packet into the storage space of voice data packets to be processed.

12. The electronic device according to claim 9, wherein execution of the instructions by the at least one processor causes the at least one processor to:
determine whether the voice data packet comprises an end identifier, wherein the end identifier is used for indicating the last voice data packet corresponding to the voice connection to which the current voice data packet belongs;
release a voice recognition example corresponding to the voice data packet, and update the state of the released voice recognition example into an idle state if the determining result shows that the voice data packet comprises an end identifier.

13. The electronic device according to claim 8, wherein execution of the instructions by the at least one processor causes the at least one processor to:
the electronic device's main thread creates a voice recognition thread for every physical core according to the quantity of the physical cores comprised by the electronic device before the current voice recognition thread acquires the voice data packet stored by the set rule.

14. The electronic device according to claim 8, wherein execution of the instructions by the at least one processor causes the at least one processor to:
generate an interrupt identifier when the sever main thread receives an external request for interrupting the electronic device;
according to the interrupt identifier, voice connections which is established in the electronic device, continue to carry out the voice recognition processing on the voice data packets corresponding to the voice connections, and after the voice recognition processing of all the voice data packets corresponding to the voice connections is completed, interrupt the voice connection;
and for voice connections which are not established in the electronic device, directly cancel requests of establishing connections with the electronic device, and stop establishing voice connections with the electronic device.

15. A non-transitory computer readable medium storing executable instructions that, when executed by an electronic device, cause the electronic device to:
a current voice recognition thread acquire a voice data packet stored according to a set rule;
call a voice recognition example to perform recognition processing on an acquired voice data packet;
determine if other voice data packets to be processed exist after completing the processing the acquired voice data packets;
if yes, return to the current voice recognition thread acquiring a voice data packet stored according to the set rule, and continue to perform voice recognition processing on other voice data packets, wherein the acquired data packet and other voice data packets belong to different voice connections.

16. The non-transitory computer readable medium according to claim 15, wherein the processor is further caused to:
call a voice recognition example corresponding to the voice data packet;
use the called voice recognition example to perform voice recognition process on the voice data packet, and push the processed voice data packet into the storage space of processed voice data packets for acquisition by the voice connection that the voice data packet belongs.

17. The non-transitory computer readable medium according to claim 16, wherein when calling the voice recognition example corresponding to the voice data packet, call a voice recognition example corresponding to the voice data packet comprises:
determining if the voice recognition example list stores the voice recognition example corresponding to the voice connection that the voice data packet belongs;
if yes, directly calling the voice recognition example corresponding to the voice connection;
and if not, calling a currently idle voice recognition example from a voice recognition example list, and establishes the correspondence relationship between the called voice recognition example and the voice connection that the voice data packet belongs, wherein the idle voice recognition example is a voice recognition example which does not establish the corresponding relationship with the voice connection.

18. The non-transitory computer readable medium according to claim 15, wherein the voice data packet stored by the set rule is stored in a following way:
the voice connection that the voice data packet belongs determines whether the voice data packet corresponding to the voice connection is stored in a storage space of voice data packets to be processed, a storage space of voice data packets which are being processed and a storage space of the processed voice data packets;
and if the voice data packet corresponding to the voice connection is not stored, storing the voice data packet into the storage space of voice data packets to be processed.

19. The non-transitory computer readable medium according to claim 16, wherein the electronic device is further caused to:
determine whether the voice data packet comprises an end identifier, wherein the end identifier is used for indicating the last voice data packet corresponding to the voice connection to which the current voice data packet belongs;
release a voice recognition example corresponding to the voice data packet, and update the state of the released voice recognition example into an idle state if the determining result shows that the voice data packet comprises an end identifier.

20. The non-transitory computer readable medium according to claim 15, wherein the electronic device is further caused to:
the electronic device's main thread creates a voice recognition thread for every physical core according to the quantity of the physical cores comprised by the electronic device before the current voice recognition thread acquires the voice data packet stored by the set rule.
